(19) United States
(12) Patent Application Publication
(10) Pub. No.: US 2006/0080740 A1
(43) Pub. Date: Apr. 13, 2006

(54) Adapting protected content for a receiving terminal

(75) Inventors: Oliver Bremer, Helsinki (FI); Sami Pippuri, Espoo (FI); Guido Cugi, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/965,229

(22) Filed: Oct. 13, 2004

(51) Int. Cl. H04N 7/16

(52) U.S. Cl. 726/26

(57) ABSTRACT

The invention relates to a method, a system, network entities and computer program products for adapting digital rights management protected content for a receiving terminal. In the method protected content is sent from a sending terminal to a content sender network entity. The content sender network entity sends information identifying the receiving terminal and at least part of the protected content to a content issuer network entity. The content issuer network entity determines an appropriate form of the protected content for the receiving terminal and sends the determined appropriate form of the protected content or information identifying the appropriate form to the content sender network entity. The content sender network entity then sends the appropriate form of the protected content to the receiving terminal.

### BACKGROUND OF THE INVENTION

1. Field of the Invention

The invention relates to digital rights management (DRM) in electronic devices. Particularly, the invention relates to a solution adapting digital rights management protected content for a receiving terminal that takes into account also the security aspects of the DRM architecture.

2. Description of the Related Art

Since the introduction of digital storage technologies more effective copyright enforcement has become an issue. Especially, the emergence of the Internet as an illicit distribution channel for copyright protected content has created a strong demand for new technologies in copyright protection. One such technology is Digital Rights Management (DRM). DRM is a common term for standards and proprietary systems where a given content item is associated with information that specifies user rights associated with it. The content item may, for example, be an audio recording, video, picture, computer program or simply a document. The user rights may comprise various rules pertaining to the use of the content item. For example, a user may be given a time limit during which the content item can be presented, in other words, rendered to the user. An allowed number of listening times, allowed device identities and partial viewing rights are other examples of rules pertaining to the use of a content item. The DRM requires that the presentation device and the presentation software in it are not hostile, that is, they participate in the enforcement of digital rights. In the presentation device there is usually a DRM agent, or in other words, a DRM engine, which enforces the DRM rights and protects the content items from illicit copying. In order to avoid making a DRM protected content item available for copying, the content item may be encrypted while it is in transit from the network to the presentation device and while it is stored in the presentation device outside of the DRM engine, for example, on a hard disk.

One standard for the DRM is the one based on Open Mobile Alliance (OMA) DRM specification. The aim of the OMA DRM is to enable controlled consumption of digital media objects by allowing content providers to express content rights. The media objects are content items such as audio clips, video clips, pictures, Java applications and documents. Content items governed by rights are referred to as assets. In the OMA DRM content rights are expressed as document objects, that is, documents written using a Rights Expression Language (REL). In order to specify the rights pertaining to an asset it is associated with a REL object. The association between a REL object and an asset may be specified explicitly by mentioning the asset's identifier in the REL object or implicitly by providing the REL object in a same message together with the asset. In the OMA DRM there are three possible methods for delivering content to a terminal and a DRM agent therein. Content is delivered to a mobile terminal in DRM messages. In a DRM message there is a media object and an optional rights object, that is, a REL object. The first method is called forward-lock. In this method no REL object is associated with the media object. The media object is sent in a DRM message, which has no REL object. Default rights known to a terminal are applied for the media object. For example, they may prevent further distribution of the media object to any other terminal. The second method is referred to as combined delivery. In the combined delivery, a media object is sent together with the REL object in a DRM message. In the third method the media object and the REL object are provided separately. They may be sent via different transports.

A terminal such as a mobile terminal (MT) applying the DRM is equipped with a DRM agent, in other words, a DRM engine. A media object or a media stream, in other words a content stream, is provided via the DRM engine to a media application for presentation to the user. The DRM engine decrypts the media object or content stream, if it has been encrypted for protection. The optional encryption has been performed in a content source using encryption that can only be decrypted using a key available to the DRM engine. The key is typically a symmetric encryption/decryption key. The mobile terminal stores also at least one rule object. The rule object is used by the DRM engine to check the user rights pertaining to a given media object. The DRM engine checks the user rights before making the media object or stream available via the media application for rendering to the user.

The aforementioned description applies both to OMA DRM 1.0 and OMA DRM 2.0. OMA DRM 2.0 is building on OMA DRM 1.0 and extends the separate delivery method by applying encryption to the rights objects based on terminal keys. Also, in OMA DRM 2.0 (and in OMA DRM 1.0 separate delivery case) rights and content are separate.

Different mobile terminals applying the DRM have different capabilities. A wallpaper, a ringing tone, an application, Java or other types of content will render differently on different terminals, depending on, e.g., a screen resolution, keyboard layout, etc. Thus, a content downloaded by a user of one terminal might not work at all or not optimally when it is sent to another user terminal having a different screen size, Java Virtual Machine, etc.

WO 98/19438 discloses a system for receiving, storing and originating multimedia messages. The system comprises a translation unit that translates some or all parts of a multimedia message into a format adapted to the presentation capabilities of a receiving user terminal. The translation unit is also part of the system. WO 98/19438 does not teach that the translation unit is able to handle DRM protected content. If protected DRM content were, however, sent in the system disclosed in WO 98/19438, the translation unit should be able to translate the protected content for the receiving user terminal in question. In order to be able to translate the protected content, the translation unit must first decrypt the protected content, adapt it and finally encrypt it. For decrypting and encrypting the translation should have in possession or have access to a decyption/encryption key. This, however, would significantly lower the security of the DRM system by unnecessarily affording non-DRM components in the infrastructure access to unencrypted DRM content.

Furthermore, a proposition has been made to the OMA DLDRM working group disclosing a method, by which a DRM Rights Issuer having the key to encrypt DRM protected content, shares this key with a network infrastructure element, e.g. a Multimedia Messaging Service (MMS) infrastructure element. The server in the operator MMS infrastructure extracts the protected content from a Multimedia Message, decrypts the content, performs standard transcoding, e.g. image resizing, re-encrypts the content, and sends it to the intended recipient. The solution has, however, several drawbacks:
Transcoding content will not work in all cases. For example, a Java application cannot be transcoded.
Transcoding content will be sub-optimal in many cases. For example, an image can be downsized to a lower resolution. Enlarging, however, will lead to a loss in quality.
Most importantly, this approach again unnecessarily lowers the security of the DRM system by unnecessarily affording non-DRM components in the infrastructure access to unencrypted DRM content.

Based on the above, there is a need for a solution that does not unnecessarily lower the security of the DRM system by unnecessarily affording non-DRM components in the infrastructure access to unencrypted DRM content.

### SUMMARY OF THE INVENTION

According to one aspect of the invention there is provided a method of handling digital rights management protected content for a receiving terminal, the method comprising: receiving protected content from a sending terminal, sending information identifying the receiving terminal and at least part of the protected content to a content issuer network entity, receiving an appropriate form of the protected content or information identifying the appropriate form from the content issuer network entity, and sending the appropriate form of the protected content to the receiving terminal.

In one embodiment of the invention, prior to sending the protected content from the content sender network entity to the content issuer network entity, the method further comprises checking the suitability of the protected content for the receiving terminal. In one embodiment of the invention, the step of checking comprises checking the suitability of the protected content for the receiving terminal based on at least one of metadata attached to the protected content and receiving terminal capabilities.

In one embodiment of the invention, the part of the protected content comprises at least a protected content identifier.

In one embodiment of the invention, the method further comprises sending a request to a rights issuer network entity for the address of the content issuer network entity, and receiving the address of the content issuer network entity in response to the request from the rights issuer network entity.

In one embodiment of the invention, the method further comprises sending capability information of the receiving terminal along with the at least part of the protected content to the content issuer network entity.

In one embodiment of the invention, the step of sending information identifying the receiving terminal and at least part of the protected content to a content issuer network entity comprises sending information identifying the receiving terminal and at least part of the protected content to a rights issuer network entity to be forwarded to the content issuer network entity by the rights issuer network entity.

In one embodiment of the invention, the method further comprises sending capability information of the receiving terminal along with the at least part of the protected content to the rights issuer network entity. In one embodiment of the invention, the part of the protected content comprises at least a protected content identifier.

In one embodiment of the invention, information identifying the appropriate form of the protected content indicates that the original protected content is suitable for the receiving terminal.

According to another aspect of the invention there is provided a method of adapting digital rights management protected content for a receiving terminal, the method comprising: receiving information identifying the receiving terminal and at least part of protected content from a content sender network entity, determining an appropriate form of the protected content for the receiving terminal based on information identifying the receiving terminal and the at least part of the protected content, and sending the appropriate form of the protected content or information identifying the appropriate form to a content sender network entity.

In one embodiment of the invention, the part of the protected content comprises at least a protected content identifier.

In one embodiment of the invention, the step of receiving information identifying the receiving terminal and the at least part of protected content from the content network entity comprises receiving information identifying the receiving terminal and the at least part of protected content via a rights issuer network entity.

In one embodiment of the invention, information identifying the receiving terminal comprises capability information of the receiving terminal.

In one embodiment of the invention, the method further comprises acquiring capability information of the receiving terminal based on information identifying the receiving terminal from an external network entity.

In one embodiment of the invention, the step of sending the appropriate form of the protected content or information identifying the appropriate form to a content sender network entity comprises sending information identifying the original protected content to the content sender network entity, if the original protected content is determined as suitable for the receiving terminal.

In one embodiment of the invention, the step of determining an appropriate form of the protected content for the receiving terminal based on information identifying the receiving terminal and the at least part of the protected content comprises decrypting the protected content, transcoding the content to an appropriate form for the receiving terminal, and encrypting the transcoded content.

In one embodiment of the invention, the step of determining an appropriate form of the protected content for the receiving terminal based on information identifying the receiving terminal and the at least part of the protected content comprises acquiring the appropriate form of the protected content from a content database.

According to another aspect of the invention there is provided a communication system of adapting digital rights management protected content. The system comprises a sending terminal, a receiving terminal, a content sender network entity connected to the sending terminal and receiving terminal via a distribution network, and a content issuer network entity connected to the content sender network entity.

The content sender network entity comprises a first receiver configured to receive protected content from the sending terminal and an appropriate form of the protected content or information identifying the appropriate form from the content issuer network entity, and a first transmitter configured to send information identifying the receiving terminal and at least part of the protected content and to send the appropriate form of the protected content to the receiving terminal.

The content issuer network entity comprises a second receiver configured to receive information identifying the receiving terminal and at least part of the protected content from a content sender network entity, a second processing entity configured to determine the appropriate form of the protected content for the receiving terminal based on information identifying the receiving terminal and the at least part of the protected content, and a second transmitter configured to send the determined appropriate form of the protected content or information identifying the appropriate form to the content sender network entity.

In one embodiment of the invention, the content sender network entity further comprises a first processing entity configured to check the suitability of the protected content for the receiving terminal.

In one embodiment of the invention, the first processing entity is configured to check the suitability of the protected content for the receiving terminal based on at least one of metadata attached to the protected content and receiving terminal capabilities.

In one embodiment of the invention, the part of the protected content comprises at least a protected content identifier.

In one embodiment of the invention, the first transmitter is configured to send a request to a rights issuer network entity for the address of the content issuer network entity and the first receiver is configured to receive the address of the content issuer network entity in response to the request from the rights issuer network entity.

In one embodiment of the invention, the first transmitter is configured to send capability information of the receiving terminal along with the at least part of the protected content to the content issuer network entity.

In one embodiment of the invention, the first transmitter is configured to send information identifying the receiving terminal and the at least part of the protected content to a rights issuer network entity to be forwarded to the content issuer network entity by the rights issuer network entity.

In one embodiment of the invention, the first transmitter is configured to send capability information of the receiving terminal along with the at least part of the protected content to the rights issuer network entity.

In one embodiment of the invention, the part of the protected content comprises at least a protected content identifier.

In one embodiment of the invention, information identifying the appropriate form indicates that the original protected content is suitable for the receiving terminal.

In one embodiment of the invention, the second receiver is configured to receive information identifying the receiving terminal and the at least part of protected content via a rights issuer network entity.

In one embodiment of the invention, information identifying the receiving terminal comprises capability information of the receiving terminal.

In one embodiment of the invention, the second processing entity is configured to acquire capability information of the receiving terminal based on information identifying the receiving terminal from an external network entity.

In one embodiment of the invention, the second transmitter is configured to send information identifying the original protected content to the content sender network entity, if the original protected content is determined as suitable for the receiving terminal.

In one embodiment of the invention, the second processing entity is configured to decrypt the protected content, to transcode the content to an appropriate form for the receiving terminal, and to encrypt the transcoded content.

In one embodiment of the invention, the second processing entity is configured to acquire the appropriate form of the protected content from a content database.

According to another aspect of the invention there is provided a content sender network entity for handling digital rights management protected content. The content sender network entity comprises a receiver configured to receive protected content from the sending terminal and a transmitter configured to send information identifying the receiving terminal and at least part of the protected content. The receiver is further configured to receive the appropriate form of the protected content or information identifying the appropriate form from the content issuer network entity and the transmitter is further configured to send the appropriate form of the protected content to the receiving terminal.

According to another aspect of the invention there is provided a content issuer network entity of adapting digital rights management protected content for a recipient terminal. The content issuer network entity comprises a receiver configured to receive information identifying the receiving terminal and at least part of the protected content from a content sender network entity, a processing entity configured to determine the appropriate form of the protected content for the receiving terminal based on information identifying the receiving terminal and the at least part of the protected content, and a transmitter configured to send the determined appropriate form of the protected content or information identifying the appropriate form to the content sender network entity.

According to another aspect of the invention there is provided a computer program product comprising code stored on at least one data-processing device readable medium, the code adapted to perform the following steps when executed on a data-processing system: receiving protected content from a sending terminal, sending information identifying the receiving terminal and at least part of the protected content to a content issuer network entity, receiving an appropriate form of the protected content or information identifying the appropriate form from the content issuer network entity, and sending the appropriate form of the protected content to the receiving terminal.

According to another aspect of the invention there is provided a computer program product comprising code stored on at least one data-processing device readable medium, the code adapted to perform the following steps when executed on a data-processing system: receiving information identifying the receiving terminal and at least part of protected content from a content sender network entity, determining an appropriate form of the protected content for the receiving terminal based on information identifying the receiving terminal and the at least part of the protected content, and sending the appropriate form of the protected content or information identifying the appropriate form to a content sender network entity.

Further characteristics of the invention are described below.

An advantage of the invention is that recipients of DRM protected content sent from one user to another will be able to use the content, thus eliminating the frustrating experience of having been sent, e.g., a nice ringing tone, from a friend, and not being able to use it.

Furthermore, an essential advantage is that the invention does not require any transcoding of protected content by any DRM unrelated network entity, thus preserving the level of quality originally created by the content owner. Also, it eliminates the need for a Rights Issuer to share the DRM key used to encrypt the content (on which the security of the DRM system depends) with other network infrastructure elements. Depending on the security level of the accompanying trust scheme (for example, a Content Management License Administrator (CMLA)), the Rights Issuer is likely to prefer keeping the distribution of the content key as limited as possible.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a signaling diagram illustrating one embodiment of method steps according to the invention;

FIG. 2 is a signaling diagram illustrating another embodiment of method steps according to the invention;

FIG. 3 is a signaling diagram illustrating another embodiment of method steps according to the invention;

FIG. 4 is a signaling diagram illustrating another embodiment of method steps according to the invention;

FIG. 5a is a block diagram illustrating one embodiment of the system according to the invention; and

FIG. 5b is a block diagram illustrating another embodiment of the system according to the invention.

### DETAILED DESCRIPTION OF THE EMBODIMENTS

Reference will now be made in detail to the embodiments of the present invention, examples of which are illustrated in the accompanying drawings.

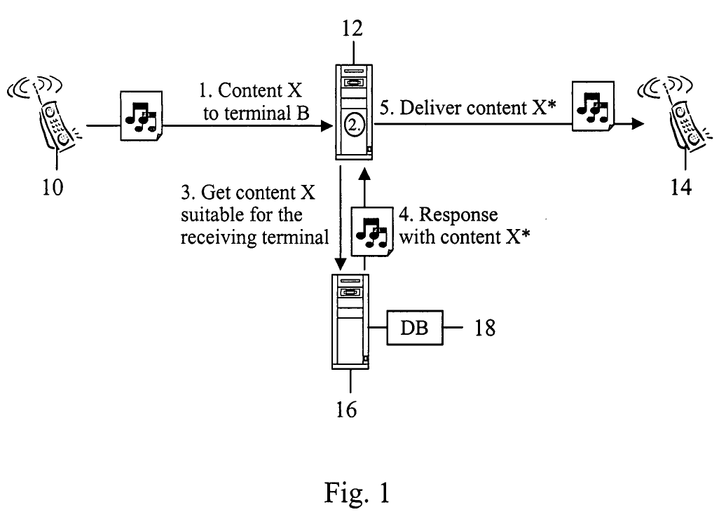

FIG. 1 discloses an embodiment of the invention. A sending terminal 10 sends (1) DRM protected content to a receiving terminal 14. The protected content refers e.g. to an audio clip, video clip, picture, Java application and document. The protected content is first transmitted to a content sender network entity 12. Content sender network entity 12 refers e.g. to a Multimedia Messaging Service Center (MMSC) in the sending/receiving terminal's network, an email proxy, an Instant Messaging (IM) server or any other appropriate network entity or application.

In the embodiment disclosed in FIG. 1, content sender network entity 12 performs the check whether the original DRM protected content is suitable for receiving terminal 14. Content sender network entity 12 may examine (2) e.g. the metadata possibly attached to the protected content and receiving terminal 14 capabilities. Terminal capabilities are signaled to content sender network entity 12 using e.g. User Agent Profile signaling. The User Agent Profile comprises information about software capabilities, media types supported by the device etc. If content sender network entity 12 is e.g. a MMSC element, the MMSC may cache terminals' UAProf information or phone model information, which UAProf information is available e.g. from manufacturers' websites.

Based on the examination, content sender network entity 12 decides whether the original protected content is suitable for sending forward to receiving terminal 14 without any modifications. If the content is deemed not suitable for the target device, content sender network entity 12 provides (3) a content issuer network entity 16 e.g. with the ContentID of the content in question and the capabilities of receiving terminal 14. ContentID of a protected content is a globally unique identifier for a Content Object. It is also possible that content sender network entity 12 provides content issuer network entity 16 with the protected content itself.

Content issuer network entity 16 then determines an appropriate form of the DRM protected content for receiving terminal 14 e.g. based on the ContentID of the protected DRM content and receiving terminal 14 capabilities. By examining the ContentID, content issuer network entity 16 can check its catalog and determine what content is actually inside the protected package, e.g. a jpeg picture of a pop star with a resolution of 160×160 pixels. Then, it determines from the capabilities of the intended recipient, that the recipient terminal has a screen resolution of, for example, 200×200 pixels. Content issuer network entity 16 then retrieves the same picture in the new resolution e.g. from a content database 18, and sends (4) this protected jpeg picture (the appropriate form of the DRM protected content) to content sender network entity 12. Content sender network entity 12 replaces the old DRM protected content with the new DRM protected content and sends (5) it to receiving terminal 14.

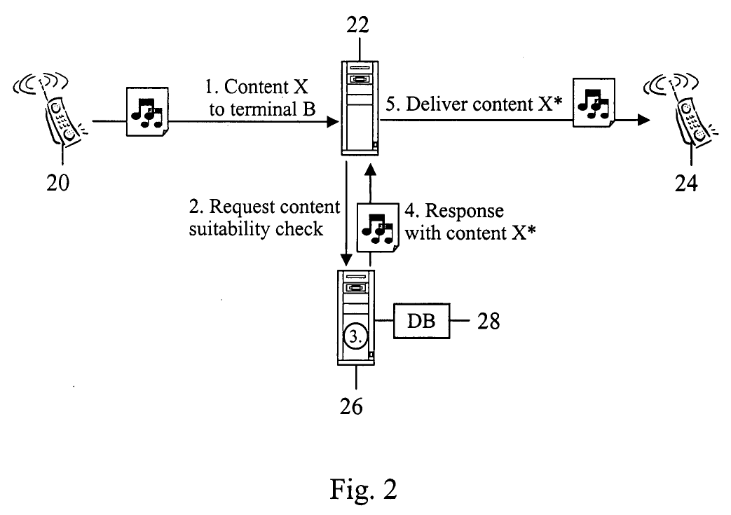

FIG. 2 discloses another embodiment of the invention. A sending terminal 20 sends (1) DRM protected content to a receiving terminal 24. The protected content refers e.g. to an audio clip, video clip, picture, Java application and document. The protected content is first transmitted to a content sender network entity 22. Content sender network entity 22 refers e.g. to a Multimedia Messaging Service Center (MMSC), email proxy, Instant Messaging (IM) server or any other appropriate network entity or application.

In the embodiment disclosed in FIG. 2, content sender network entity 22 provides (2) a content issuer network entity 26 e.g. with the ContentID of the content in question and the capabilities of receiving terminal 24. It is also possible that content sender network entity 12 provides content issuer network entity 16 with the protected content itself. Terminal capabilities are signaled to content sender network entity 22 using e.g. User Agent Profile signaling. The User Agent Profile comprises information about software capabilities, media types supported by the device etc. ContentID of a protected content is a globally unique identifier for a Content Object. In this embodiment, content sender network entity 22 does not check whether the original DRM protected content is suitable for receiving terminal 24.

Instead, in this embodiment content issuer network entity 26 checks (3) whether the original DRM protected content is suitable for receiving terminal 24. Content issuer network entity 26 determines based on the ContentID and receiving terminal 24 capabilities whether the original protected content is suitable for sending forward to receiving terminal 24 without any modifications. If the original protected content is not suitable for receiving terminal 24, content issuer network entity 26 determines an appropriate form of the DRM protected content for receiving terminal 24. By examining the ContentID, content issuer network entity 26 can check its catalog and determine what content is actually inside the protected package, e.g. a jpeg picture of a pop star with resolution 160×160 pixels. Then, it determines from the capabilities of the intended recipient, that the recipient terminal has a screen resolution of, for example, 200×200 pixels. Content issuer network entity 26 then retrieves the same picture in the new resolution e.g. from a content database 28, and sends (4) this protected jpeg picture (the appropriate form of the DRM protected content) to content sender network entity 22. Content sender network entity 22 then sends (5) the appropriate form of the DRM protected content to receiving terminal 24. If the original DRM protected content is suitable for receiving terminal 24, content issuer network entity 26 simply instructs content sender network entity 22 to proceed with sending the original content to receiving terminal 24.

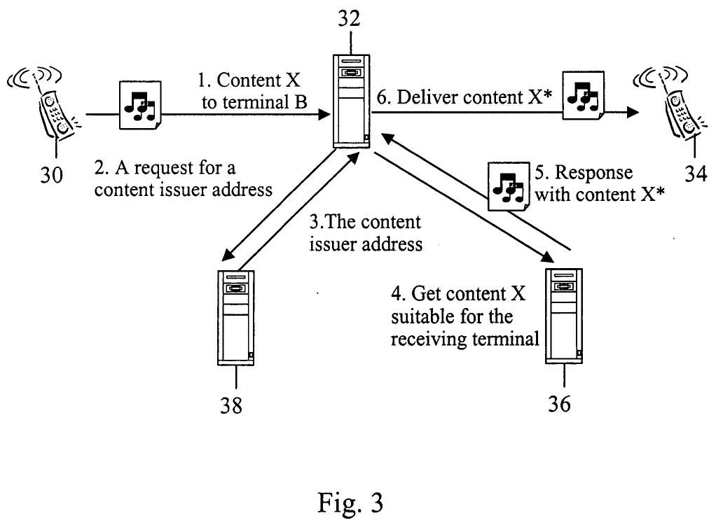

FIG. 3 discloses another embodiment of the invention. A sending terminal 30 sends (1) DRM protected content to a receiving terminal 34. The protected content refers e.g. to an audio clip, video clip, picture, Java application and document. The protected content is first transmitted to a content sender network entity 32. Content sender network entity 32 refers e.g. to a Multimedia Messaging Service Center (MMSC), email proxy, Instant Messaging (IM) server or any other appropriate network entity or application.

Content sender network entity 32 may check whether the original DRM protected content is suitable for receiving terminal 34. Every piece of protected content that can be sent from one device to another (OMA DRM 1.0 separate delivery and OMA DRM 2.0) contains a rights issuer URL (Uniform Resource Locator). Thus, if content sender network entity 32 is not able to determine how to reach content issuer network entity 36, it may query (2) a rights issuer 38 for the URL. Rights issuer 38 returns (3) the URL of content issuer network entity 36 back to content sender network entity 32.

Receiving terminal 34 capabilities may be signaled to content sender network entity 32 using e.g. User Agent Profile signaling. The User Agent Profile comprises information about software capabilities, media types supported by the device etc. If content sender network entity 32 is e.g. a MMSC element, the MMSC may cache terminals' UAProf information or phone model information, to which UAProf information is available e.g. from manufacturers' websites.

Content sender network entity 32 decides whether the original protected content is suitable for sending forward to receiving terminal 34 without any modifications. If the content is deemed not suitable for the target device, content sender network entity 32 provides (4) a content issuer network entity 36 e.g. with the ContentID of the content in question and the capabilities of receiving terminal 34. ContentID of a protected content is a globally unique identifier for a Content Object. It is also possible that content sender network entity 32 provides content issuer network entity 36 with the protected content itself.

Content issuer network entity 36 then determines an appropriate form of the DRM protected content for receiving terminal 34 e.g. based on the ContentID of the protected DRM content and receiving terminal 14 capabilities. By examining the ContentID, content issuer network entity 36 can check its catalog and determine what content is actually inside the protected package, e.g. a jpeg picture of a pop star with a resolution of 160×160 pixels. Then, it determines from the capabilities of the intended recipient, that the recipient terminal has a screen resolution of, for example, 200×200 pixels. Content issuer network entity 16 then retrieves the same picture in the new resolution e.g. from a content database, and sends (5) this protected jpeg picture (the appropriate form of the DRM protected content) to content sender network entity 32. Content sender network entity 32 replaces the old DRM protected content with the new DRM protected content and sends (6) it to receiving terminal 34.

In another embodiment of FIG. 3, content issuer network entity 36 may check whether the original DRM protected content is suitable for receiving terminal 34. Content issuer network entity 36 determines based on the ContentID and receiving terminal 34 capabilities whether the original protected content is suitable for sending forward to receiving terminal 34 without any modifications. If the original protected content is not suitable for receiving terminal 34, content issuer network entity 36 determines an appropriate form of the DRM protected content for receiving terminal 34.

Content issuer network entity 36 and rights issuer network entity 38 may be running on the same computer or different computers.

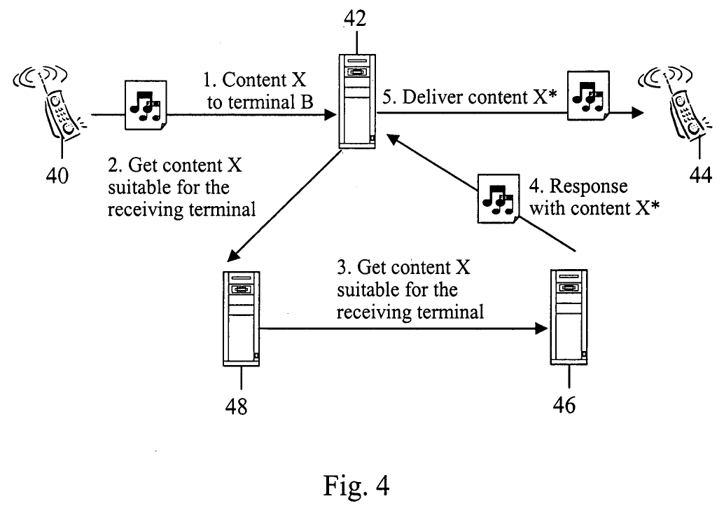

FIG. 4 discloses another embodiment of the invention. A sending terminal 40 sends (1) DRM protected content to a receiving terminal 44. The protected content refers e.g. to an audio clip, video clip, picture, Java application and document. The protected content is first transmitted to a content sender network entity 42. Content sender network entity 42 refers e.g. to a Multimedia Messaging Service Center (MMSC), email proxy, Instant Messaging (IM) server or any other appropriate network entity or application.

Content sender network entity 42 may check whether the original DRM protected content is suitable for receiving terminal 44. Every piece of protected content that can be sent from one device to another (OMA DRM 1.0 separate delivery and OMA DRM 2.0) contains a rights issuer URL (Uniform Resource Locator). Thus, if the content is deemed not suitable for receiving terminal 44 and if content sender network entity 42 is not able to determine how to reach content issuer network entity 46, it sends (3) ContentID of the protected content in question and capability information of receiving terminal 44 to a rights issuer 48. Receiving terminal 44 capabilities may be signaled to content sender network entity 42 using e.g. User Agent Profile signaling. The User Agent Profile comprises information about software capabilities, media types supported by the device etc. If content sender network entity 42 is e.g. a MMSC element, the MMSC may cache terminals' UAProf information or phone model information, to which UAProf information is available e.g. from manufacturers' websites.

Rights issuer 48 is configured to determine the URL of content issuer network entity 46 and to forward information received from content sender network entity to content issuer network entity 46.

Content issuer network entity 46 then determines an appropriate form of the DRM protected content for receiving terminal 44 e.g. based on the ContentID of the protected DRM content and receiving terminal 44 capabilities. By examining the ContentID, content issuer network entity 46 can check its catalog and determine what content is actually inside the protected package, e.g. a jpeg picture of a pop star with a resolution of 160×160 pixels. Then, it determines from the capabilities of the intended recipient, that the recipient terminal has a screen resolution of, for example, 200×200 pixels. Content issuer network entity 46 then retrieves the same picture in the new resolution e.g. from a content database, and sends (4) this protected jpeg picture (the appropriate form of the DRM protected content) to content sender network entity 42. Content sender network entity 42 then replaces the old DRM protected content with the new DRM protected content and sends (5) it to receiving terminal 44.

In another embodiment of FIG. 4, content issuer network entity 46 may check whether the original DRM protected content is suitable for receiving terminal 44. Content issuer network entity 46 determines based on the ContentID and receiving terminal 44 capabilities whether the original protected content is suitable for sending forward to receiving terminal 44 without any modifications. If the original protected content is not suitable for receiving terminal 44, content issuer network entity 46 determines an appropriate form of the DRM protected content for receiving terminal 44.

The aforementioned embodiments disclose that the content issuer network entity checks the appropriate form of the protected content from a content database. In another embodiment, the content issuer network entity transcodes the protected content itself. The content issuer network entity first decrypts the protected content, transcodes the content to an appropriate form for the receiving terminal, and finally encrypts the transcoded content. The content issuer network entity is a DRM related element. Therefore, it has access to the content encryption key, namely when generating the protected content in the first place.

The aforementioned embodiments also disclose that the content sender network entity has access to the capability information of the receiving terminal (UAProf information). In another embodiment of the invention, also the content issuer network entity is able to acquire the capability information of the receiving terminal. In such an embodiment, the content sender network entity sends to the content issuer network entity information identifying the receiving terminal, e.g. an IP address or a Mobile Subscriber ISDN number (MSISDN). Based on identifying information, the content issuer network entity is able to acquire capability information of the receiving terminal.

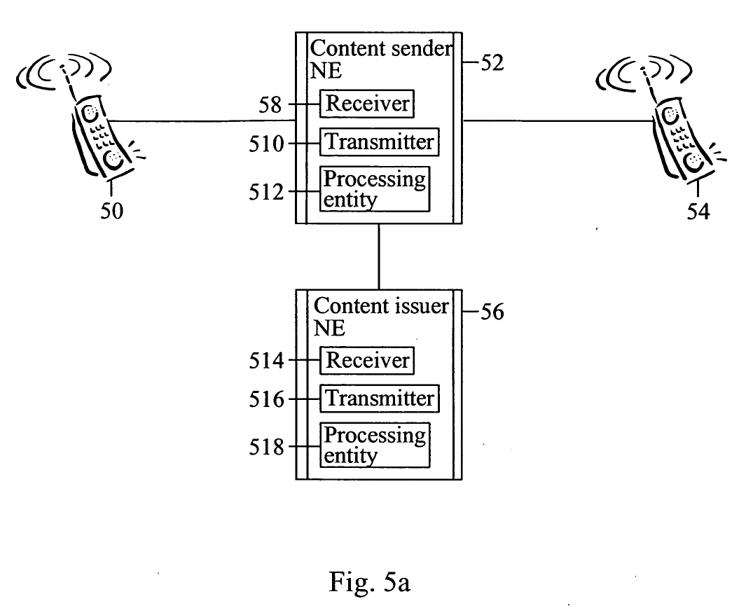

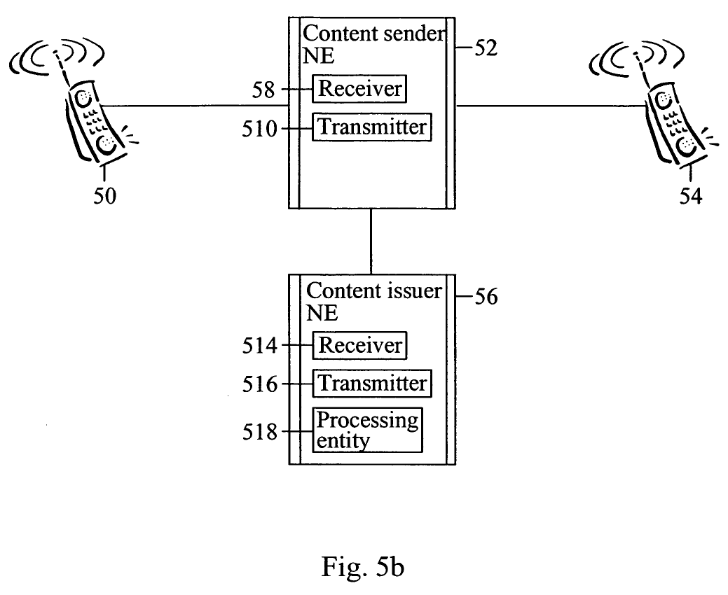

FIG. 5a is a block diagram illustrating the system according to the invention. A receiver 58 of a content sender network entity 52 receives DRM protected content from a sending terminal 50. Before the DRM content is delivered to a receiving terminal 54, content sender network entity 52 checks with a processing entity 512 the suitability of the DRM protected content for receiving terminal 54. The check is made e.g. based on based on at least one of metadata attached to the protected content and receiving terminal 54 capabilities.

If the DRM protected content has to be modified, a transmitter 510 is configured to send information identifying receiving terminal 54 and at least part of the protected content to a content issuer network entity 56.

A receiver 514 of content issuer network entity 56 is configured to receive the data sent by content sender network entity 52. A processing entity 518 is configured to determine an appropriate form of the protected content for receiving terminal 54 based on information identifying receiving terminal 54 and the at least part of the protected content. Information identifying receiving terminal 54 may comprise e.g. capability information of receiving terminal 54. Processing entity 518 may be configured to acquire the appropriate form of the protected content from a local content storage database (not shown).

A transmitter 516 is configured to send the determined appropriate form of the DRM protected content or information identifying the appropriate form to content sender network entity 52.

Receiver 58 is further configured to receive the appropriate form of the DRM protected content or information identifying the appropriate form from content issuer network entity 56 and transmitter 510 is configured to send the appropriate form of the DRM protected content to receiving terminal 54. Information identifying the appropriate form may indicate that the original protected content is suitable for receiving terminal 54.

In one embodiment of FIG. 5a, transmitter 510 is configured to send a request to a rights issuer network entity (not shown) for the address of content issuer network entity 56. This may happen when content sender network entity 52 does not know the address of content issuer network entity 56. Receiver 58 is then configured to receive the address of content issuer network entity 56 in response to the request.

In another embodiment of FIG. 5a, transmitter 510 is configured to send information identifying receiving terminal 54 and the at least part of the protected content to a rights issuer network entity (not shown). The rights issuer network entity then forwards information identifying the receiving terminal and the at least part of the protected content to content issuer network entity 56. Information identifying receiving terminal 54 may comprise capability information of receiving terminal 54. Furthermore, the part of the protected content comprises e.g. a protected content identifier.

In one embodiment of FIG. 5a, receiver 514 is configured to receive information identifying receiving terminal 54 and the at least part of the protected content from a rights issuer network entity (not shown). Information identifying receiving terminal 54 comprises e.g. capability information of receiving terminal 54.

If content sender network entity 52 does not send capability information of receiving terminal 54 to content issuer network entity 56, processing entity 518 is configured to acquire capability information of receiving terminal 54 based on information identifying receiving terminal 54 from an external network entity.

Information identifying receiving terminal 54 may refer to any applicable piece of information, e.g. to an IP address or a Mobile Subscriber ISDN number (MSISDN).

If the original protected content is determined as suitable for receiving terminal 54, transmitter 516 is configured to send information identifying the original protected content to content sender network entity 52.

In one embodiment of FIG. 5a, processing entity 518 is configured to decrypt the protected content, to transcode the content to an appropriate form for the receiving terminal, and to encrypt the transcoded content.

FIG. 5b is a block diagram illustrating another embodiment of the system according to the invention. The functionality of the system is almost the same as in FIG. 5a. The difference between FIGS. 5a and 5b is that in FIG. 5b content sender network entity 52 does not check the suitability of the DRM protected content for receiving terminal 54. Instead, it provides content issuer network entity 56 with information identifying receiving terminal 54 and at least part of the protected content.

Processing entity 518 of content issuer network entity 56 determines an appropriate form of the protected content for receiving terminal 54 based on information identifying receiving terminal 54 and the at least part of the protected content received from content sender network entity 52.

The receiving terminal and sending terminal disclosed in the invention may be any appropriate terminal device, e.g. a mobile phone, a Personal Digital Assistant (PDA), a server computer, a personal computer etc. Correspondingly, information can be exchanged between the terminals and network entities disclosed in the invention using appropriate communication networks, e.g. data communication networks, such as the Internet, mobile communication networks, such as the Global System for Mobile communications (GSM), Wideband Code Division Multiple Access (WCDMA) or any other.

Receivers, processing entities and transmitters in FIGS. 5a and 5b are in practice implemented e.g. using at least one of software and hardware. In other words, they may refer to software processes and hardware receivers, transmitters and processors or any combination thereof that are used to implement the invention.

An essential advantage of the invention is that the invention does not require any transcoding of protected content by any DRM unrelated network entity (e.g. the content sender network entity), thus preserving the level of quality originally created by the content owner. Also, it eliminates the need for a Rights Issuer to share the DRM key used to encrypt the content (on which the security of the DRM system depends) with other network infrastructure elements.

It will be evident to a person skilled in the art that with the advancement of technology, the basic idea of the invention may be implemented in various ways. The invention and its embodiments are thus not limited to the examples described above; instead they may vary within the scope of the claims.

1. A method of handling digital rights management protected content for a receiving terminal, the method comprising:
receiving protected content from a sending terminal;
sending information identifying the receiving terminal and at least part of the protected content to a content issuer network entity;
receiving an appropriate form of the protected content or information identifying the appropriate form from the content issuer network entity; and
sending the appropriate form of the protected content to the receiving terminal.

2. The method according to claim 1, wherein prior to sending the protected content from the content sender network entity to the content issuer network entity, the method further comprises:
checking suitability of the protected content for the receiving terminal.

3. The method according to claim 2, wherein the step of checking comprises:
checking the suitability of the protected content for the receiving terminal based on at least one of metadata attached to the protected content and receiving terminal capabilities.

4. The method according to claim 1, wherein the part of the protected content comprises at least a protected content identifier.

5. The method according to claim 1, further comprising:
sending a request to a rights issuer network entity for the address of the content issuer network entity; and
receiving the address of the content issuer network entity in response to the request from the rights issuer network entity.

6. The method according to claim 1, wherein the method further comprises:
sending capability information of the receiving terminal along with the at least part of the protected content to the content issuer network entity.

7. The method according to claim 1, wherein the step of sending information identifying the receiving terminal and at least part of the protected content to a content issuer network entity comprises:
sending information identifying the receiving terminal and at least part of the protected content to a rights issuer network entity to be forwarded to the content issuer network entity by the rights issuer network entity.

8. The method according to claim 7, wherein the method further comprises:
sending capability information of the receiving terminal along with the at least part of the protected content to the rights issuer network entity.

9. The method according to claim 8, wherein the part of the protected content comprises at least a protected content identifier.

10. The method according to claim 1, wherein information identifying the appropriate form indicates that the original protected content is suitable for the receiving terminal.

11. A method of adapting digital rights management protected content for a receiving terminal, the method comprising:
receiving information identifying the receiving terminal and at least part of protected content from a content sender network entity;
determining an appropriate form of the protected content for the receiving terminal based on information identifying the receiving terminal and the at least part of the protected content; and
sending the appropriate form of the protected content or information identifying the appropriate form to a content sender network entity.

12. The method according to claim 11, wherein the part of the protected content comprises at least a protected content identifier.

13. The method according to claim 11, wherein the step of receiving information identifying the receiving terminal and the at least part of protected content from the content network entity comprises receiving information identifying the receiving terminal and the at least part of protected content via a rights issuer network entity.

14. The method according to claim 11, wherein information identifying the receiving terminal comprises capability information of the receiving terminal.

15. The method according to claim 11, further comprising:
acquiring capability information of the receiving terminal based on information identifying the receiving terminal from an external network entity.

16. The method according to claim 11, wherein the step of sending the appropriate form of the protected content or information identifying the appropriate form to a content sender network entity comprises:
sending information identifying original protected content to the content sender network entity, if the original protected content is determined as suitable for the receiving terminal.

17. The method according to claim 11, wherein the step of determining an appropriate form of the protected content for the receiving terminal based on information identifying the receiving terminal and the at least part of the protected content comprises:
decrypting the protected content;
transcoding the content to an appropriate form for the receiving terminal; and
encrypting the transcoded content.

18. The method according to claim 11, wherein the step of determining an appropriate form of the protected content for the receiving terminal based on information identifying the receiving terminal and the at least part of the protected content comprises:
acquiring the appropriate form of the protected content from a content database.

19. A communication system of adapting digital rights management protected content, comprising:
a sending terminal;
a receiving terminal;
a content sender network entity connected to the sending terminal and receiving terminal via a distribution network;
a content issuer network entity connected to the content sender network entity;
wherein the content sender network entity comprises:
a first receiver configured to receive protected content from the sending terminal and an appropriate form of the protected content or information identifying the appropriate form from the content issuer network entity;
a first transmitter configured to send information identifying the receiving terminal and at least part of the protected content and to send the appropriate form of the protected content to the receiving terminal;
wherein the content issuer network entity comprises:
a second receiver configured to receive information identifying the receiving terminal and at least part of the protected content from a content sender network entity;
a second processing entity configured to determine the appropriate form of the protected content for the receiving terminal based on information identifying the receiving terminal and the at least part of the protected content; and
a second transmitter configured to send the determined appropriate form of the protected content or information identifying the appropriate form to the content sender network entity.

20. The communication system according to claim 19, wherein the content sender network entity further comprises a first processing entity configured to check the suitability of the protected content for the receiving terminal.

21. The communication system according to claim 20, wherein the first processing entity is configured to check the suitability of the protected content for the receiving terminal based on at least one of metadata attached to the protected content and receiving terminal capabilities.

22. The communication system according to claim 19, wherein the part of the protected content comprises at least a protected content identifier.

23. The communication system according to claim 19, wherein the first transmitter is configured to send a request to a rights issuer network entity for the address of the content issuer network entity and the first receiver is configured to receive the address of the content issuer network entity in response to the request from the rights issuer network entity.

24. The communication system according to claim 19, wherein the first transmitter is configured to send capability information of the receiving terminal along with the at least part of the protected content to the content issuer network entity.

25. The communication system according to claim 19, wherein the first transmitter is configured to send information identifying the receiving terminal and the at least part of the protected content to a rights issuer network entity to be forwarded to the content issuer network entity by the rights issuer network entity.

26. The communication system according to claim 25, wherein the first transmitter is configured to send capability information of the receiving terminal along with the at least part of the protected content to the rights issuer network entity.

27. The communication system according to claim 26, wherein the part of the protected content comprises at least a protected content identifier.

28. The communication system according to claim 19, wherein information identifying the appropriate form indicates that original protected content is suitable for the receiving terminal.

29. The communication system according to claim 19, wherein the second receiver is configured to receive information identifying the receiving terminal and the at least part of protected content via a rights issuer network entity.

30. The communication system according to claim 29, wherein information identifying the receiving terminal comprises capability information of the receiving terminal.

31. The communication system according to claim 19, wherein the second processing entity is configured to acquire capability information of the receiving terminal based on information identifying the receiving terminal from an external network entity.

32. The communication system according to claim 19, wherein the second transmitter is configured to send information identifying the original protected content to the content sender network entity, if the original protected content is determined as suitable for the receiving terminal.

33. The communication system according to claim 19, wherein the second processing entity is configured to decrypt the protected content, to transcode the content to an appropriate form for the receiving terminal, and to encrypt the transcoded content.

34. The communication system according to claim 19, wherein the second processing entity is configured to acquire the appropriate form of the protected content from a content database.

35. A content sender network entity for handling digital rights management protected content, comprising:
a receiver configured to receive protected content from the sending terminal;
a transmitter configured to send information identifying the receiving terminal and at least part of the protected content;
wherein the receiver is further configured to receive the appropriate form of the protected content or information identifying the appropriate form from the content issuer network entity and the transmitter is further configured to send the appropriate form of the protected content to the receiving terminal.

36. The content sender network entity according to claim 35, further comprising further a processing entity configured to check the suitability of the protected content for the receiving terminal.

37. The content sender network entity according to claim 36, wherein the processing entity is configured to check the suitability of the protected content for the receiving terminal based on at least one of metadata attached to the protected content and receiving terminal capabilities.

38. The content sender network entity according to claim 35, wherein the part of the protected content comprises at least a protected content identifier.

39. The content sender network entity according to claim 35, wherein the transmitter is configured to send a request to a rights issuer network entity for the address of the content issuer network entity and the receiver is configured to receive the address of the content issuer network entity in response to the request from the rights issuer network entity.

40. The content sender network entity according to claim 35, wherein the transmitter is configured to send capability information of the receiving terminal along with the at least part of the protected content to the content issuer network entity.

41. The content sender network entity according to claim 35, wherein the transmitter is configured to send information identifying the receiving terminal and the at least part of the protected content to a rights issuer network entity to be forwarded to the content issuer network entity by the rights issuer network entity.

42. The content sender network entity according to claim 41, wherein the transmitter is configured to send capability information of the receiving terminal along with the at least part of the protected content to the rights issuer network entity.

43. The content sender network entity according to claim 42, wherein the part of the protected content comprises at least a protected content identifier.

44. The content sender network entity according to claim 35, wherein information identifying the appropriate form indicates that the original protected content is suitable for the receiving terminal.

45. A content issuer network entity of adapting digital rights management protected content for a recipient terminal, comprising:
a receiver configured to receive information identifying the receiving terminal and at least part of the protected content from a content sender network entity;
a processing entity configured to determine the appropriate form of the protected content for the receiving terminal based on information identifying the receiving terminal and the at least part of the protected content; and
a transmitter configured to send the determined appropriate form of the protected content or information identifying the appropriate form to the content sender network entity.

46. The content issuer network entity according to claim 45, wherein the receiver is configured to receive information identifying the receiving terminal and the at least part of the protected content via a rights issuer network entity.

47. The content issuer network entity according to claim 46, wherein information identifying the receiving terminal comprises capability information of the receiving terminal.

48. The content issuer network entity according to claim 45, wherein the processing entity is configured to acquire capability information of the receiving terminal based on information identifying the receiving terminal from an external network entity.

49. The content issuer network entity according to claim 45, wherein the transmitter is configured to send information identifying the original protected content to the content sender network entity, if the original protected content is determined as suitable for the receiving terminal.

50. The content issuer network entity according to claim 45, wherein the processing entity is configured to decrypt the protected content, to transcode the content to an appropriate form for the receiving terminal, and to encrypt the transcoded content.

51. The content issuer network entity according to claim 45, wherein the processing entity is configured to acquire the appropriate form of the protected content from a content database.

52. A computer program product comprising code stored on at least one data-processing device readable medium, the code adapted to perform the following steps when executed on a data-processing system:
receiving protected content from a sending terminal;
sending information identifying the receiving terminal and at least part of the protected content to a content issuer network entity;
receiving an appropriate form of the protected content or information identifying the appropriate form from the content issuer network entity; and
sending the appropriate form of the protected content to the receiving terminal.

53. The computer program product according to claim 52, further comprising code stored on at least one data-processing device readable medium, the code adapted to perform the following step when executed on a data-processing system:
checking suitability of the protected content for the receiving terminal.

54. The computer program product according to claim 53, further comprising code stored on at least one data-processing device readable medium, the code adapted to perform the following step when executed on a data-processing system:
checking the suitability of the protected content for the receiving terminal based on at least one of metadata attached to the protected content and receiving terminal capabilities.

55. The computer program product according to claim 52, wherein the part of the protected content comprises at least a protected content identifier.

56. The computer program product according to claim 52, further comprising code stored on at least one data-processing device readable medium, the code adapted to perform the following step when executed on a data-processing system:
sending a request to a rights issuer network entity for the address of the content issuer network entity; and
receiving the address of the content issuer network entity in response to the request from the rights issuer network entity.

57. The computer program product according to claim 52, further comprising code stored on at least one data-processing device readable medium, the code adapted to perform the following step when executed on a data-processing system:
sending capability information of the receiving terminal along with the at least part of the protected content to the content issuer network entity.

58. The computer program product according to claim 52, further comprising code stored on at least one data-processing device readable medium, the code adapted to perform the following step when executed on a data-processing system:
sending information identifying the receiving terminal and at least part of the protected content to a rights issuer network entity to be forwarded to the content issuer network entity by the rights issuer network entity.

59. The computer program product according to claim 58, further comprising code stored on at least one data-processing device readable medium, the code adapted to perform the following step when executed on a data-processing system:
sending capability information of the receiving terminal along with the at least part of the protected content to the rights issuer network entity.

60. The computer program product according to claim 59, wherein the part of the protected content comprises at least a protected content identifier.

61. The computer program product according to claim 52, wherein information identifying the appropriate form indicates that the original protected content is suitable for the receiving terminal.

62. A computer program product comprising code stored on at least one data-processing device readable medium, the code adapted to perform the following steps when executed on a data-processing system:
receiving information identifying the receiving terminal and at least part of protected content from a content sender network entity;
determining an appropriate form of the protected content for the receiving terminal based on information identifying the receiving terminal and the at least part of the protected content; and
sending the appropriate form of the protected content or information identifying the appropriate form to a content sender network entity.

63. The computer program product according to claim 62, wherein the part of the protected content comprises at least a protected content identifier.

64. The computer program product according to claim 62, further comprising code stored on at least one data-processing device readable medium, the code adapted to perform the following step when executed on a data-processing system:
receiving information identifying the receiving terminal and the at least part of protected content via a rights issuer network entity.

65. The computer program product according to claim 62, wherein information identifying the receiving terminal comprises capability information of the receiving terminal.

66. The computer program product according to claim 62, further comprising code stored on at least one data-processing device readable medium, the code adapted to perform the following step when executed on a data-processing system:
acquiring capability information of the receiving terminal based on information identifying the receiving terminal from an external network entity.

67. The computer program product according to claim 62, further comprising code stored on at least one data-processing device readable medium, the code adapted to perform the following step when executed on a data-processing system:
sending information identifying the original protected content to the content sender network entity, if the original protected content is determined as suitable for the receiving terminal.

68. The computer program product according to claim 62, further comprising code stored on at least one data-processing device readable medium, the code adapted to perform the following step when executed on a data-processing system:
decrypting the protected content;
transcoding the content to an appropriate form for the receiving terminal; and
encrypting the transcoded content.

69. The computer program product according to claim 62, further comprising code stored on at least one data-processing device readable medium, the code adapted to perform the following step when executed on a data-processing system:
acquiring the appropriate form of the protected content from a content database.
